(19) United States
(12) Patent Application Publication
(10) Pub. No.: US 2019/0110172 A1
(43) Pub. Date: Apr. 11, 2019

(54) MESH NETWORKS FOR DISASTER RELIEF

(71) Applicant: Unisys Corporation, Blue Bell, PA (US)

(72) Inventors: DAVID STRONG, IRVINE, CA (US); ANDREW WARD BEALE, IRVINE, CA (US); DEREK W. PAUL, IRVINE, CA (US)

(21) Appl. No.: 15/725,760

(22) Filed: Oct. 5, 2017

(51) Int. Cl. H04W 4/22; H04W 76/02; H04W 76/00; H04W 24/02; H04L 12/24; H04L 12/18

(52) U.S. Cl. CPC H04W 4/22; H04W 76/023; H04W 76/007; H04W 84/18; H04W 24/02; H04L 41/12; H04L 12/1895; H04W 76/002

(57) ABSTRACT

A mesh network system and method for use in an area affected by a natural disaster. The system includes a first network node that has Wi-Fi capability and a first Wi-Fi coverage area. The system also includes at least one second network node, coupled to the first network node, with the at least one second network node having Wi-Fi capability and a second Wi-Fi coverage area outside of the first Wi-Fi coverage area. The first network node and the at least one second network node are coupled together via at least one radio transceiver to form a network route within the mesh network. A first communication device located within the area affected by the natural disaster and operably coupled to the first network node communicates with a second communication device located within the area affected by the natural disaster and coupled to the at least one second network node via the network route within the mesh network.

### BACKGROUND

### Field

The instant disclosure relates to mesh networks, and in particular to mesh network systems and methods for use in natural disaster relief.

### Description of the Related Art

After a natural disaster, the area affected by the natural disaster likely will experience critical demand for food, water, medical attention and other emergency services. Communications are a critical component of any relief effort for the area affected by the natural disaster. As a result of the natural disaster, vital infrastructure for communication between teams of first responders (e.g., power, cellular telephone, radio, television and Internet infrastructure) likely either will be damaged, completely lost or may never have existed. Communication between the general public and first responders likely will be non-existent, as will communication between family members.

There is a need to provide access to basic communications and data to first responders and to the general public in areas that have been affected by a natural disaster.

### SUMMARY

Disclosed is a mesh network system and method for use in an area affected by a natural disaster. The system includes a first network node that has Wi-Fi capability and a first Wi-Fi coverage area. The system also includes at least one second network node, coupled to the first network node, with the at least one second network node having Wi-Fi capability and a second Wi-Fi coverage area outside of the first Wi-Fi coverage area. The first network node and the at least one second network node are coupled together via at least one radio transceiver to form a network route within the mesh network. A first communication device located within the area affected by the natural disaster and operably coupled to the first network node communicates with a second communication device located within the area affected by the natural disaster and coupled to the at least one second network node via the network route within the mesh network.

### BRIEF DESCRIPTION OF THE DRAWINGS

FIG. 1 is a schematic view of a basic mesh network for disaster relief, according to an embodiment;

FIG. 2 is a schematic view of an expanded mesh network for disaster relief, according to an embodiment;

FIG. 3 is a schematic view of communication channels for first responders using a mesh network for disaster relief, according to an embodiment;

FIG. 4 is a schematic view of communication channels for the general public using a mesh network for disaster relief, according to an embodiment;

FIG. 5 is a schematic view of a smartphone mesh, using a mesh network for disaster relief, according to an embodiment;

FIG. 6 is a schematic view of an expanded mesh network for disaster relief, showing social media conduits, according to an embodiment; and

FIG. 7 is a schematic view of a mesh network for disaster relief, showing the dissemination of warning beacons, according to an embodiment.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

In the event of a natural disaster, many problems typically exist for the area affected by the natural disaster. There often is no available food or water, as well as little if any access to medical and other emergency services. With respect to communication capabilities in the affected area, there typically is little or no power, if there was any power to begin with. Also, there likely is severe if not complete damage to some or all phone networks, and radio, television and Internet infrastructure. Therefore, in areas affected by a natural disaster, there are limited communication and coordination options available.

According to an embodiment, possible solutions for communication and coordination capabilities in areas affected by a natural disaster involve the use of one or more mesh networks. A mesh network is a communications network made up of nodes, such as radio nodes, organized in a mesh topology. Each mesh node in the mesh network relays data for the network, and all mesh nodes cooperate in the distribution of data throughout the network. A fully connected mesh network is a mesh network in which each node has connectivity to every other node in the mesh network. A mesh network can be a wireless mesh network (WMN) and/or a wired mesh network.

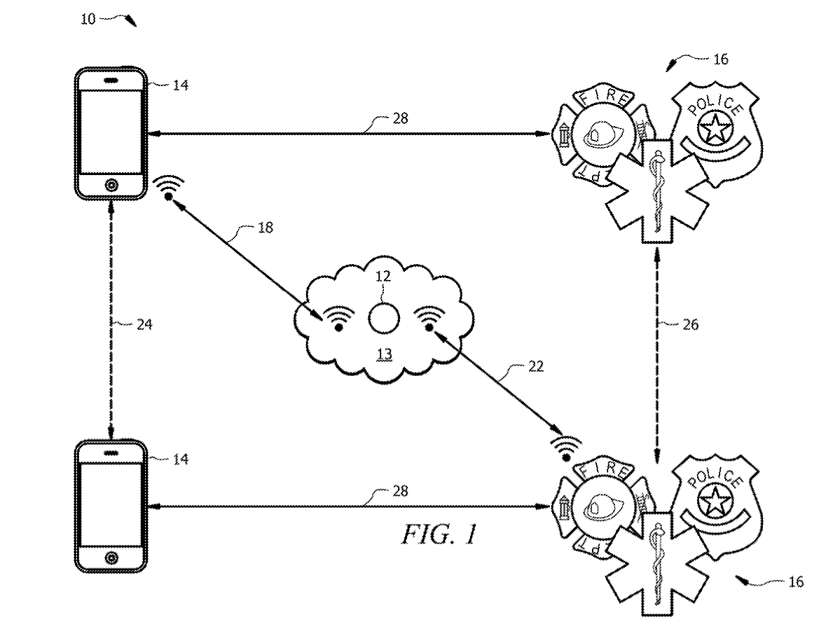

FIG. 1 is a schematic view of a basic mesh network 10 for disaster relief, according to an embodiment. The mesh network includes multiple network nodes or mesh nodes (such as radio nodes and/or other suitable communication nodes), although only one network node 12 is shown in the mesh network 10 for purposes of explanation and clarity. The network node 12 can have Wi-Fi capability (shown generally as Wi-Fi coverage 13), thus allowing various communication devices to communicate via one or more of the network nodes 12. A network node is a connection point that can, among other things, receive, store, process, analyze, update, create and/or send data along network routes within the mesh network. Each network node 12, whether it is a start point, a redistribution point or an endpoint for data transmissions, can have programmed or engineered capability to, among other things, recognize, process, analyze, update and/or forward transmissions to other network nodes 12.

As shown, the personal devices 14 of members of the general public (e.g., smartphone, tablet computer, laptop computer or other suitable personal device) have an appropriate communication channel 18 with the network node 12. Also, the communication devices 16 of first responders (shown generally as 16) have an appropriate communication channel 22 with the network node 12. Thus, members of the general public and first responders can communicate with each other via the network node 12. Also, depending on the state of the area affected by the natural disaster, the personal devices 14 of members of the general public may be able to communicate directly with one another (and/or with other communities of interest) via appropriate communication channels 24. Similarly, the communication devices 16 of first responders may be able to communicate directly with one another (and/or with other communities of interest) via appropriate communication channels 26. Also, the personal devices 14 of members of the general public may be able to communicate directly with the communication devices 16 of the first responders (and/or with other communities of interest) via appropriate communication channels 28. According to an embodiment, one or more of the communication channels 18, 22, 24, and 28 can include multiple secure channels in the respective communication path.

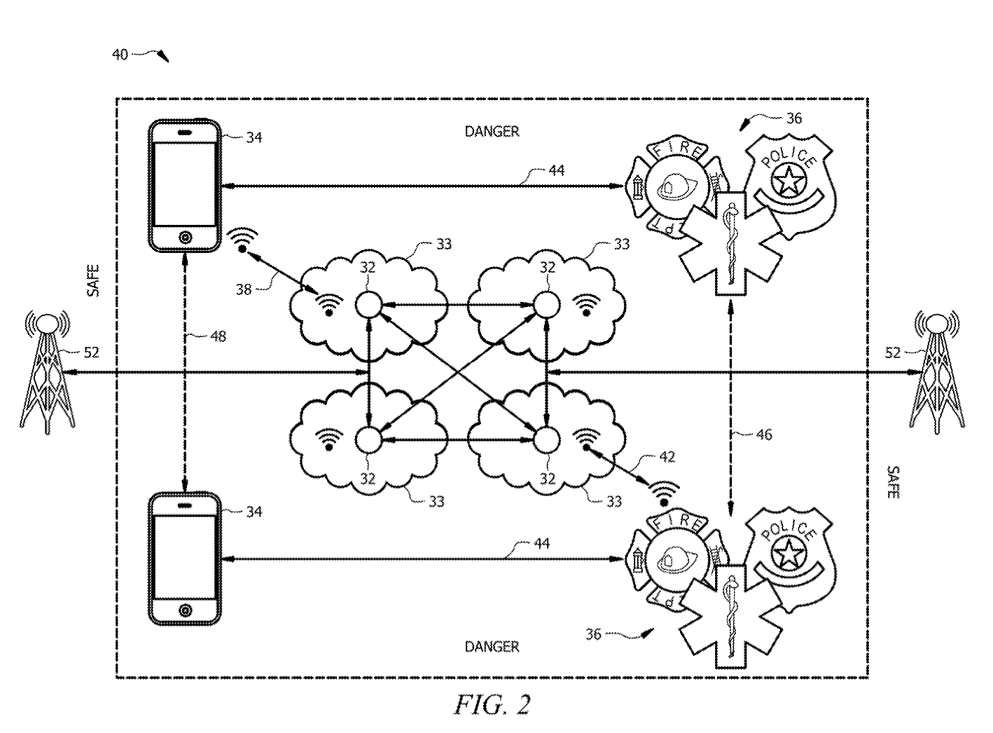

FIG. 2 is a schematic view of an expanded mesh network 40 for disaster relief, according to an embodiment. The mesh network 40 includes multiple network nodes or mesh nodes 32, each with Wi-Fi coverage 33. However, the Wi-Fi coverage areas 33 of each network node 32 do not overlap, which indicates that the network nodes 32 are out of Wi-Fi range of one another. However, as shown, each network node 32 is coupled or connected to every other network node 32 in the mesh network 40, e.g., via a suitable number of radio transceivers, which can reach longer distances than conventional Wi-Fi coverage 33. Crosstalk between the network nodes 32 is handled by the radio transceivers. Also, it should be understood that additional network nodes can be added to boost coverage for the mesh network and/or for redundancy.

As shown, one or more personal devices 34 of the general public can communicate with one or more of the network nodes 32 via one or more appropriate communication channels 38. Similarly, one or more communication devices of first responders (shown generally as 36) can communicate with one or more of the network nodes 32 via one or more appropriate communication channels 42. According to an embodiment, each network node 32 is configured with a front facing Wi-Fi access point to allow one or more personal devices 34 of the general public and one or more communication devices 36 of first responders to connect to one or more of the network nodes 32.

Members of the general public and the first responders can communicate with each other via one or more of the network nodes 32. In this manner, the use of the mesh network 40 allows members of the general public and the first responders to communicate with one another via one or more of the network nodes 32, rather than attempting to communicate directly via direct channels 44, which may be unavailable in an area affected by a natural disaster (shown generally as DANGER). Depending on the state of communication channels within the area affected by the natural disaster, direct communication channels between first responders (shown generally as communication channel 46) and/or direct communication channels between members of the general public (shown generally as communication channel 48) may be available (shown generally as SAFE) or may not be available (shown generally as DANGER).

Also, according to an embodiment, the mesh network 40 can have a fully connected mesh network node topology, i.e., each network node 32 is connected to every other network node 32 in the mesh network 40. As such, communications received by any one of the network nodes 32 can be propagated along a path or network route by hopping from one network node to another network node, until the communication reaches its desired destination. Therefore, communications from the personal device 34 of a member of the general public or the communication device 36 of a first responder can reach its destination via a network route along one or more of the network nodes 32. Such network reliability via its network node re-routing capability is crucial in areas affected by a natural disaster, because various or even many locations within an affected area may be without power or even basic communication networks. The use of a fully connected mesh network works to overcome such shortcomings within such affected areas.

One or more transmitter towers 52 (and/or other appropriate infrastructure) located in the SAFE area provide the ability for a sender in the DANGER area to pass SMS (short message service) messages, email messages, or other appropriate information out of the DANGER area to working infrastructure in the SAFE area. The transmitter towers 52 (and/or other appropriate infrastructure) include SMS and email gateways that are capable of forwarding SMS and email messages to recipients that may be in a different geographical region. Likewise, a reply to such messages would pass through or from the transmitter towers 52 (and/or other appropriate infrastructure) located in the SAFE area back into the DANGER area to the sender in the DANGER area.

According to an embodiment, the network nodes 32 typically weigh less than 0.5 pounds each, and typically are not much larger than a pack of playing cards, although other configurations for the network nodes 32 are possible. The relatively light weight and small form factor of each network node 32 allows each network node 32 to be easily carried into an affected area for deployment. Each network node 32 consumes relatively little power (e.g., about 5 watts under load), so each network node 32 can be battery operated or run by solar power.

According to an embodiment, the use of a mesh network in an area affected by a natural disaster provides many advantages. The multiple network nodes of the mesh network provide a relatively small footprint, and provide relatively low power consumption even though the mesh network includes suitable processing and input output (I/O) capabilities. The mesh network serves as a reliable backbone for communication and data access in the affected area. Such a mesh network allows for text messages, possibly email communications, and maybe even voice communications. The communications made possible by the mesh network allows for appropriate inventory and resource management, e.g., where are supplies and in what quantities. The mesh network also allows access to local data, e.g., maps of affected areas and emergency protocols. As discussed hereinabove, the mesh network, via the multiple network nodes, allows communication between first responders, between first responders and the general public, and between members of the general public.

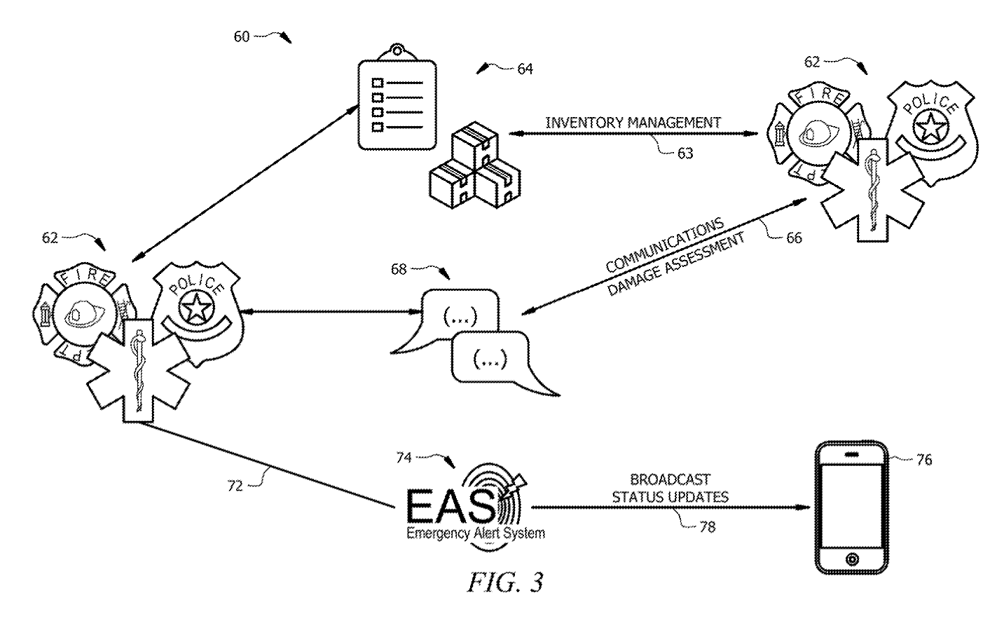

FIG. 3 is a schematic view of communication channels 60 for first responders using a mesh network for disaster relief, according to an embodiment. As discussed hereinabove, the mesh network serves as a reliable backbone for communication and data access by first responders in areas affected by a natural disaster. For example, the mesh network provides first responders 62 with appropriate access channels (shown as 63) to data (shown as 64), e.g., for appropriate inventory and resource management. The mesh network also provides first responders 62 with appropriate channels (shown as 66) for text messages, possibly email communications, and maybe even voice communications (shown generally as 68), e.g., for damage assessment and other vital communications. The mesh network also provides first responders 62 with appropriate channels (shown as 72) to other working infrastructure 74, which can be used to broadcast status updates and other information to devices 76 of members of the general public via appropriate communication channels (shown as 78).

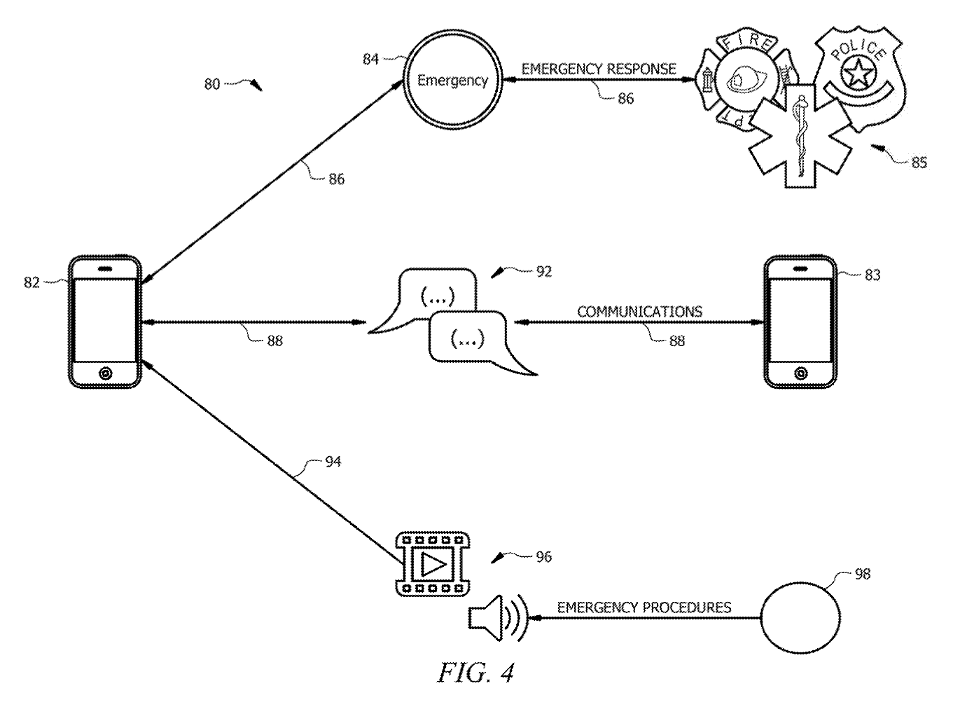

FIG. 4 is a schematic view of communication channels 80 for members of the general public using a mesh network for disaster relief, according to an embodiment. As discussed hereinabove, the mesh network serves as a reliable backbone for communication and data access by members of the general public in areas affected by a natural disaster. For example, the mesh network provides members of the general public (via their communication devices 82) with the ability to request emergency services (e.g., a 911 call) to first responders 85, via appropriate communications channels 86. The mesh network also provides members of the general public (via their communication devices 82) with appropriate channels (shown as 88) for text messages, possibly email communications, and maybe even voice communications (shown generally as 92), e.g., for communicating with other members of the general public (via their communication devices 83). The mesh network also provides members of the general public (via their communication devices 82) with appropriate channels (shown as 94) for access to emergency protocols and procedures 96, which may be transmitted by appropriate local authorities (e.g., via a network node 98). Such emergency protocols and procedures 96 may be transmitted by local authorities as low quality audio and video.

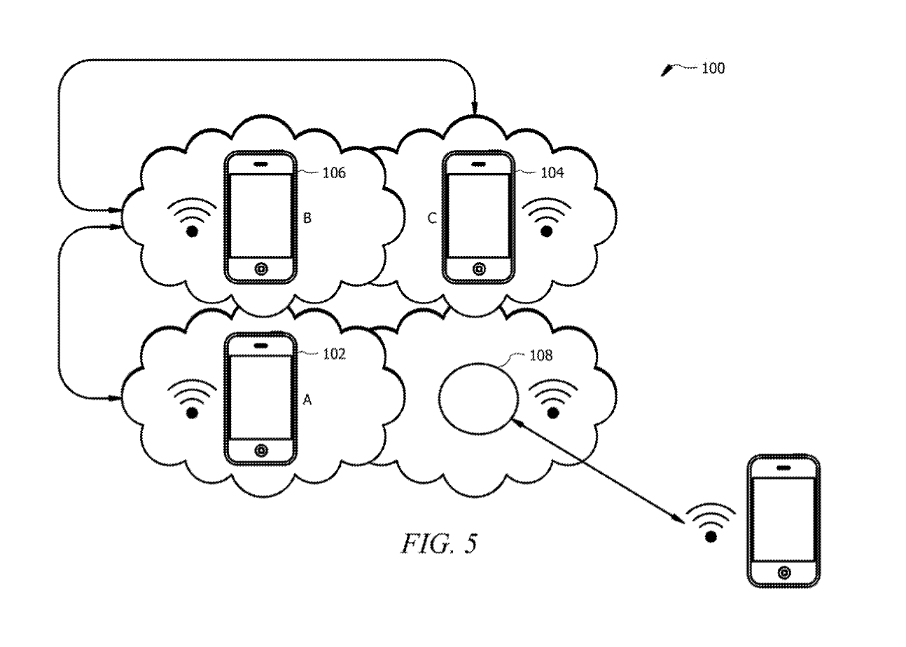

According to an embodiment, the mesh network also may be able to support peer to per applications between communication devices of members of the general public (and first responders). FIG. 5 is a schematic view of a smartphone mesh 100, using a mesh network for disaster relief, according to an embodiment. In the example shown, the communication device of user A (communication device 102) is out of Wi-Fi range of the communication device of user C (communication device 104). However, with an appropriate peer-to-peer application, the communication device 102 of user A can communicate with the communication device 104 of user C through a communication device 106 of a user B, assuming the communication device 102 of user A is within Wi-Fi range of the communication device 106 of user B, and the communication device 106 of user B is within Wi-Fi range of the communication device 104 of user C. Also, it should be understood that a network node 108 can provide additional Wi-Fi coverage area, if necessary.

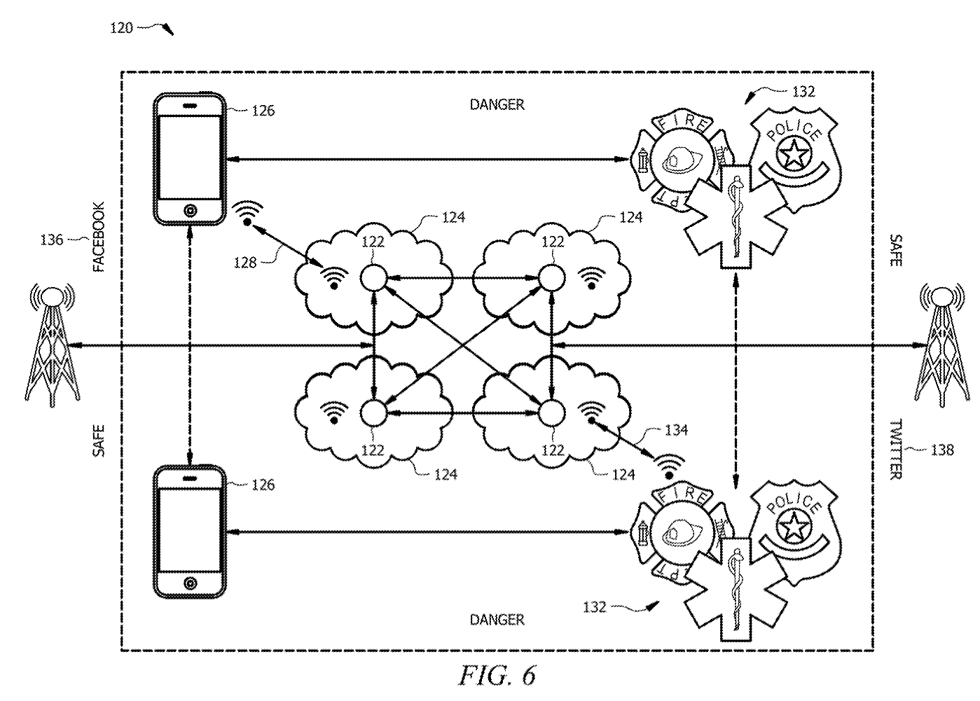

Also, according to an embodiment, the mesh network is useful as a social media conduit. FIG. 6 is a schematic view of an expanded mesh network 120 for disaster relief, showing social media conduits, according to an embodiment. The mesh network 120 includes multiple network nodes 122, each with Wi-Fi coverage 124. However, the Wi-Fi coverage areas 124 of each network node 122 do not overlap, which indicates that the network nodes 122 are out of Wi-Fi range of one another. However, as shown, each network node 122 is connected to every other network node 122 in the mesh network 120, e.g., via a suitable number of radio transceivers, which can reach longer distances than conventional Wi-Fi coverage 124. Crosstalk between the network nodes 122 is handled by the radio transceivers.

As shown, one or more of the network nodes 122 can communicate with one or more personal devices 126 of the general public via one or more appropriate communication channels 128. Similarly, one or more of the network nodes 122 can communicate with one or more communication devices of first responders (shown generally as 132) via one or more appropriate communication channels 134. Therefore, if social media, such as Facebook 136 and/or Twitter 138, is able to communicate with any one or more of the network nodes 122, such social media can be accessed by users (i.e., members of the general public and first responders) and allow such users to communicate with one another.

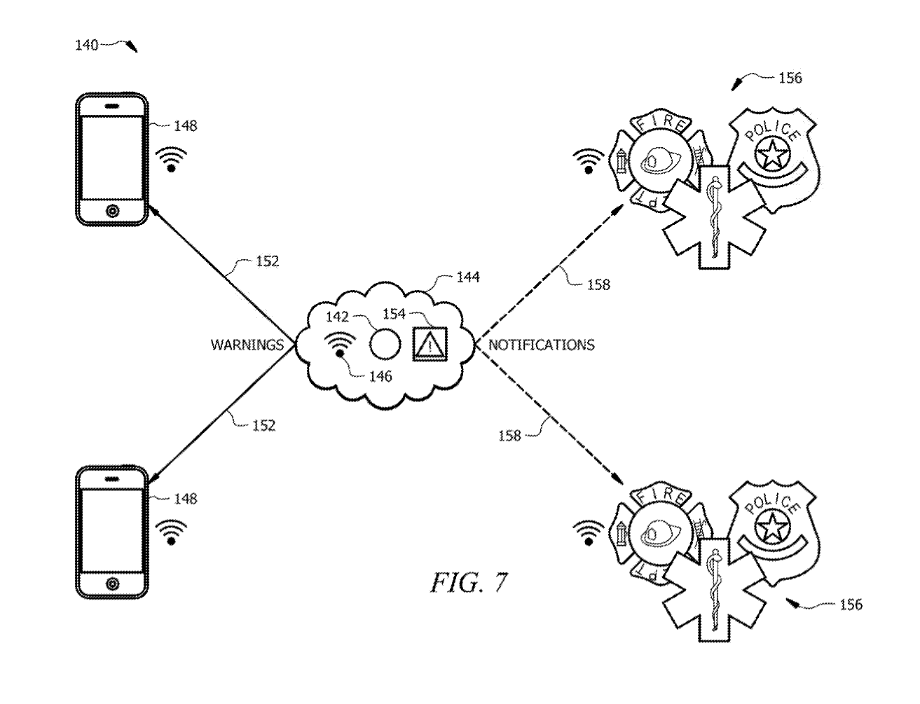

Also, according to an embodiment, the mesh network can be useful for the dissemination of warning beacons, e.g., in hazardous areas within the general area affected by a natural disaster. FIG. 7 is a schematic view of a mesh network 140 for disaster relief, showing the dissemination of warning beacons, according to an embodiment. The mesh network 140 includes at least one network node 142 with suitable Wi-Fi coverage 144. The network node 142 can be deployed in a particularly hazardous area within the general area affected by a natural disaster, e.g., hiking trails where conditions can change rapidly, areas prone to flash flooding, and areas that may be severely polluted. Alternatively, the network node 142 also can be deployed in protected habitats and nature reserves.

As shown in FIG. 7, the network node 142 is capable of transmitting warnings 146 to communication devices 148 of members of the general public via appropriate communication channels 152. In this manner, members of the general public can get alerts, via their communication devices 148, when members of the general public are approaching or getting too close to a hazardous area (shown generally as 154). The network node 142 also is capable of transmitting notifications to first responders 156 via appropriate communication channels 158. In this manner, first responders 156 can be notified of activity that is dangerously close to hazardous areas.

Alternatively, one or more sensors that are capable of communicating with one or more network nodes 142 can be deployed in a hazardous area within the general area affected by a natural disaster. The network nodes 142 may or may not also be deployed in the hazardous area. The sensors are capable of sending alert information, via one or more network nodes 142, to first responders 156 or other appropriate parties if the sensor detects the presence of a member of the general public approaching or entering the hazardous area.

According to an embodiment, one or more of the mesh networks described hereinabove can be deployed for additional uses. For example, one or more of the mesh networks described hereinabove can be used for ad-hoc surveillance, e.g., in conjunction with security personnel wearing body cameras or carrying smartphone devices or other similar devices. In such application, the mesh network provides secure channels for the security personnel. The mesh network also provides video storage and/or video streaming, as well as other data, such as sensor data and text messages. The mesh network also provides a controlled coverage area for the security personnel. In such application, one or more of the network nodes can have one or more different configurations, e.g., as an access point, as a relay, and/or for surveillance only.

According to an embodiment, one or more of the mesh networks described hereinabove can be used in conjunction with communication technologies other than those described hereinabove. For example, one or more of the mesh networks described hereinabove can be used to support short wave radio communications (i.e., HAM operators), satellite communications, and other suitable communication technologies.

It will be apparent to those skilled in the art that many changes and substitutions can be made to the embodiments described herein without departing from the spirit and scope of the disclosure as defined by the appended claims and their full scope of equivalents.

1. A mesh network system for use in an area affected by a natural disaster, the mesh network comprising:
a first network node, wherein the first network node has Wi-Fi capability and a first Wi-Fi coverage area; and
at least one second network node coupled to the first network node, wherein the at least one second network node has Wi-Fi capability and a second Wi-Fi coverage area outside of the first Wi-Fi coverage area,
wherein the first network node and the at least one second network node are coupled together via at least one radio transceiver to form a network route within the mesh network,
wherein a first communication device located within the area affected by the natural disaster and operably coupled to the first network node communicates with a second communication device located within the area affected by the natural disaster and coupled to the at least one second network node via the network route within the mesh network.

2. The system as recited in claim 1, wherein each of the first and the at least one second network node is operable to perform at least one of receive, store, process, analyze, update and send data to another network node along the network route within the mesh network.

3. The system as recited in claim 1, wherein the at least one network node further comprises a plurality of network nodes, and wherein each network node of a portion of the plurality of network nodes is coupled to the first network node and is coupled to every other network of the portion of the plurality of network nodes via at least one radio transceiver.

4. The system as recited in claim 1, wherein the at least one network node further comprises a plurality of network nodes, and wherein each network node of the plurality of network nodes is coupled to the first network node and is coupled to every other network of the plurality of network nodes via at least one radio transceiver.

5. The system as recited in claim 1, wherein the first communication device belongs to a member of the general public or to a first responder.

6. The system as recited in claim 1, wherein the second communication device belongs to a member of the general public or to a first responder.

7. The system as recited in claim 1, wherein the first communication device belongs to a first responder, wherein the second communication device belongs to a first responder, and wherein at least one of the first and second communication devices accesses at least one of inventory data, resource management data, communications data and damage assessment data from at least one of the network nodes within the mesh network.

8. The system as recited in claim 1, wherein the first communication device belongs to a first responder, wherein the second communication device belongs to a first responder, and wherein the first communication device provides at least one of inventory data, resource management data, communications data and damage assessment data to the second communication device via at least one of the network nodes within the mesh network.

9. The system as recited in claim 1, wherein the first communication device belongs to a first responder, wherein the second communication device belongs to a member of the general public, and wherein the first communication device broadcasts status updates to the second communication device via at least one of the network nodes within the mesh network.

10. The system as recited in claim 1, wherein the first communication device belongs to a member of the general public, wherein the second communication device belongs to a first responder, and wherein the first communication device accesses emergency response information transmitted by the second communication device via at least one of the network nodes within the mesh network.

11. The system as recited in claim 1, wherein the first communication device belongs to a member of the general public, wherein the second communication device belongs to a member of the general public, and wherein the first communication device accesses communications data transmitted by the second communication device via at least one of the network nodes within the mesh network.

12. The system as recited in claim 1, wherein the first communication device belongs to a member of the general public, wherein the second communication device belongs to a member of a local authority, and wherein the first communication device accesses emergency protocols and procedures transmitted by the second communication device via at least one of the network nodes within the mesh network.

13. The system as recited in claim 1, wherein the first communication device is within Wi-Fi range of at least one network node within the mesh network, wherein the second communication device is within Wi-Fi range of at least one network node within the mesh network, wherein the first communication device is out of Wi-Fi range of the second communication device, and wherein the first communication device communicates with the second communication device through a third communication device that is within Wi-Fi range of at least one network node within the mesh network.

14. The system as recited in claim 1, wherein at least one social media application communicates with at least one network node within the mesh network in such a way that at least one of the first and second communication devices can access the social media application via at least one of the network nodes within the mesh network.

15. The system as recited in claim 1, wherein at least one of the first and second network nodes is deployed in a hazardous area, wherein the first communication device belongs to a member of the general public, and wherein the first communication device receives a warning or alert beacon transmitted by at least one of the network nodes within the mesh network when the first communication device moves into the hazardous area.

16. The system as recited in claim 1, wherein at least one of the first and second network nodes is deployed in a hazardous area, wherein the first communication device belongs to a first responder, and wherein the first communication device receives notification from at least one of the network nodes within the mesh network of activity that occurs close to or within the hazardous area.

17. The system as recited in claim 1, wherein at least one of the first and second network nodes is a radio node.

18. A method for providing communication to an area affected by a natural disaster, the method comprising:
providing a first network node, wherein the first network node has Wi-Fi capability and a first Wi-Fi coverage area; and
providing at least one second network node coupled to the first network node, wherein the at least one second network node has Wi-Fi capability and a second Wi-Fi coverage area outside of the first Wi-Fi coverage area,
wherein the first network node and the at least one second network node are coupled together via at least one radio transceiver to form a network route within the mesh network,
wherein a first communication device located within the area affected by the natural disaster and operably coupled to the first network node communicates with a second communication device located within the area affected by the natural disaster and coupled to the at least one second network node via the network route within the mesh network.
